(19) United States
(12) Patent Application Publication
(10) Pub. No.: US 2026/0292388 A1
(43) Pub. Date: Sep. 24, 2026

(54) EARPHONE

(71) Applicant: Anker Innovations Technology Co., Ltd., CHANGSHA (CN)

(72) Inventor: Bixiang YAN, SHENZHEN (CN)

(21) Appl. No.: 19/571,521

(22) Filed: Mar. 19, 2026

(30) Foreign Application Priority Data
Mar. 24, 2025 (CN) 202510358553.2
Mar. 24, 2025 (CN) 202520532145.X

(51) Int. Cl. H04R 1/10; H04R 17/10

(52) U.S. Cl. CPC H04R 1/1083; H04R 1/1016; H04R 1/1041; H04R 1/105; H04R 17/10

(57) ABSTRACT

An earphone includes a wearing part, a sound-production part, a first speaker, and a second speaker. The wearing part is configured to be disposed on an ear of a user. The sound-production part includes a housing and a sound-emission nozzle, the housing is connected to the wearing part, and the sound-emission nozzle defines a first sound-emission hole. The sound-emission nozzle is telescopically movable relative to the housing, so that a distance between the first sound-emission hole and an ear canal opening of the user is adjustable when the earphone is worn by the user. The first speaker is disposed in the sound-emission nozzle, and the second speaker is disposed in the housing.

### CROSS-REFERENCE TO RELATED APPLICATIONS

The present application claims priorities to Chinese Patent Application No. 202520532145.X, filed on Mar. 24, 2025, and Chinese Patent Application No. 202510358553.2, filed on Mar. 24, 2025, both of which are herein incorporated by reference in their entirety.

### TECHNICAL FIELD

The present disclosure relates to the technical field of acoustic devices, and in particular to an earphone.

### BACKGROUND

Open earphones do not completely isolate external sounds during use, allowing the wearer to hear ambient sounds, such as the sound of vehicles driving or someone calling out. This characteristic is very important in outdoor activities such as running, cycling, or when walking on the street. This characteristic can effectively prevent accidents by ensuring the wearer can still hear the ambient sounds, thereby improving personal safety during use. In contrast, in-ear earphones are directly inserted into the ear canals, which provides better external noise isolation and delivers the audio more directly into the ears. Therefore, the in-ear earphones have advantages in reproducing audio details and low-frequency performance.

In real life, due to consumers often switching between different life scenarios, there is a high demand for dual-form earphones that combine the advantages of both the open earphones and the in-ear earphones.

### SUMMARY OF THE DISCLOSURE

The embodiments of the present disclosure provide an earphone including a wearing part, a sound-production part, a first speaker, and a second speaker. The wearing part is configured to be disposed on an ear of a user. The sound-production part includes a housing and a sound-emission nozzle, the housing is connected to the wearing part, and the sound-emission nozzle defines a first sound-emission hole. The sound-emission nozzle is telescopically movable relative to the housing, so that a distance between the first sound-emission hole and an ear canal opening of the user is adjustable when the earphone is worn by the user. The first speaker is disposed in the sound-emission nozzle, and the second speaker is disposed in the housing.

The embodiments of the present disclosure further provide an earphone including a sound-production part, a first speaker, and a second speaker. The sound-production part includes a housing and a sound-emission nozzle. The sound-emission nozzle defines a first sound-emission hole. The sound-emission nozzle is telescopically movable relative to the housing, so that a distance between the first sound-emission hole and an ear canal opening of a user is adjustable when the earphone is worn by the user. The first speaker is disposed in the sound-emission nozzle. The second speaker is disposed in the housing.

### BRIEF DESCRIPTION OF THE DRAWINGS

In order to more clearly illustrate the technical solutions in some embodiments of the present disclosure or in the related art, hereinafter, the accompanying drawings that are used in the description of some embodiments or the related art will be briefly described. The accompanying drawings in the description below are merely the accompanying drawings in some embodiments of the present disclosure. For those of ordinary skill in the art, other accompanying drawings can be obtained based on the structures shown in these accompanying drawings without any creative efforts.

FIG. 1 is a structural schematic view of an open earphone in an embodiment of the present disclosure.

FIG. 2 is a structural schematic view illustrating a sound-production part and an ear cap in an embodiment of the present disclosure.

FIG. 3 is a partial cross-sectional structural schematic view illustrating the sound-production part and the ear cap of FIG. 2.

FIG. 4 is a partial cross-sectional structural schematic view of a sound-emission nozzle of FIG. 2 in a first position.

FIG. 5 is a partial cross-sectional structural schematic view of the sound-emission nozzle of FIG. 2 in a second position.

FIG. 6 is an exploded structural schematic view illustrating a partial structure of the open earphone of FIG. 1.

FIG. 7 is another exploded structural schematic view illustrating the partial structure of the open earphone in FIG. 1.

FIG. 8 is a structural block view of the sound-production part in an embodiment of the present disclosure.

The implementation of the purpose, the functional characteristics, and the advantages of the present disclosure will be further described below in conjunction with the embodiments and with reference to the accompanying drawings.

### DETAILED DESCRIPTION

In order to make the purpose, the technical solutions and the advantages of the present disclosure clearer, the embodiments of the present disclosure are further described in detail below with reference to the accompanying drawings.

When the following description involves the accompanying drawings, unless otherwise indicated, the same reference numerals in different accompanying drawings refer to the same or similar elements. Implementations described in the following exemplary embodiments do not represent all implementations consistent with the present disclosure. On the contrary, the implementations are merely examples of apparatuses and methods that are described in detail in the appended claims and consistent with some aspects of the present disclosure.

In the description of the present disclosure, the terms “first”, “second”, etc. are only used for description and cannot be understood as indicating or implying relative importance. For those skilled in the art, the specific meanings of the above terms in the present disclosure can be understood according to specific situations. In addition, in the description of the present disclosure, unless otherwise specified, the term “multiple” refers to two or more. The term “and/or” describes a relationship between related objects, indicating that there may be three types of relationships. For example, A and/or B, which may represent: the existence of A alone, the existence of A and B at the same time, and the existence of B alone. The character “/” generally indicates that the object before the character “/” and the object after the character “/” are in an “or” relationship.

Unless otherwise defined, all technical and scientific terms used in the present disclosure have the same meanings as those commonly understood by those skilled in the art belonging to the present disclosure. The terms used in the present disclosure are only for the purpose of describing specific embodiments and are not intended to limit the present disclosure. The term “and/or” used in the present disclosure includes any one and all combinations of one or more related listed items.

An earphone may be a pair of conversion units that receive electrical signals from a media player or a receiver, and convert the electrical signals into audible sound waves using speakers close to ears.

From perspective of development of entire audio industry, wireless earphones are still considered a relatively new product. The wireless earphones are earphones that use wireless communication technologies such as Bluetooth to achieve wireless connection, so that the wireless earphones can wirelessly transmit audio with phones or other devices. The main advantages of the wireless earphones include the absence of wires, enhanced portability, and convenience in use.

There are many types of wireless earphones, and open earphones that may be directly attached to the user’s ears are usually relatively small in size and convenient to use. The open earphones may be applied to various scenarios such as commuting, office working, meetings, or sport activities, and are therefore widely favored by consumers.

However, for existing open earphones that are attached to the user’s ears, a sound-production port of the open earphone is usually not adjustable once the open earphone is worn. However, in practice, different users have different ear sizes, which can result in different distances between the sound-production port and the user’s ear canal opening after wearing the open earphones. For the user with larger ears, the distance between the sound-production port and the user’s ear canal opening is too large, which can easily result in insufficient volume of the sound transmitted from the sound-production port to the user’s ear canal opening, leading to poor listening effects and poor user experience.

There is a continuing need for earphones that can provide enhanced acoustic performance and adaptability for varying user anatomical structures. For example, in open wearing scenarios, the user has higher demands for layering and richness of sound quality. However, a single speaker is difficult to meet the user’ expectation for the sound quality in this scenario, especially in terms of balancing bass and treble.

Therefore, in some embodiments, an open earphone 100 is provided, and the open earphone 100 is capable of achieving favorable listening effects and favorable user experience for different users.

That is, in some embodiments, an open earphone is provided, and the open earphone is suitable for a user to use in different scenarios and has excellent sound quality effects.

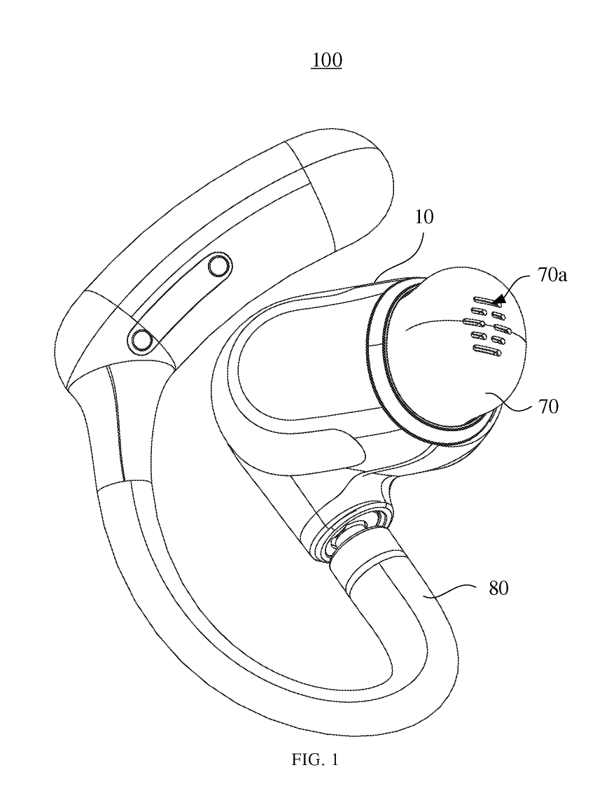

Referring to FIG. 1, in some embodiments, the open earphone 100 includes a sound-production part 10 and a wearing part 80 connected to the sound-production part 10. The sound-production part 10 is configured to generate sound signals, and the wearing part 80 is configured to cooperate with the sound-production part 10, so that the open earphone 100 is worn on the user’s ear. The wearing part 80 may be designed in the shape of an ear-hook or an ear-clip, so as to ensure stability of wearing the open earphone 100.

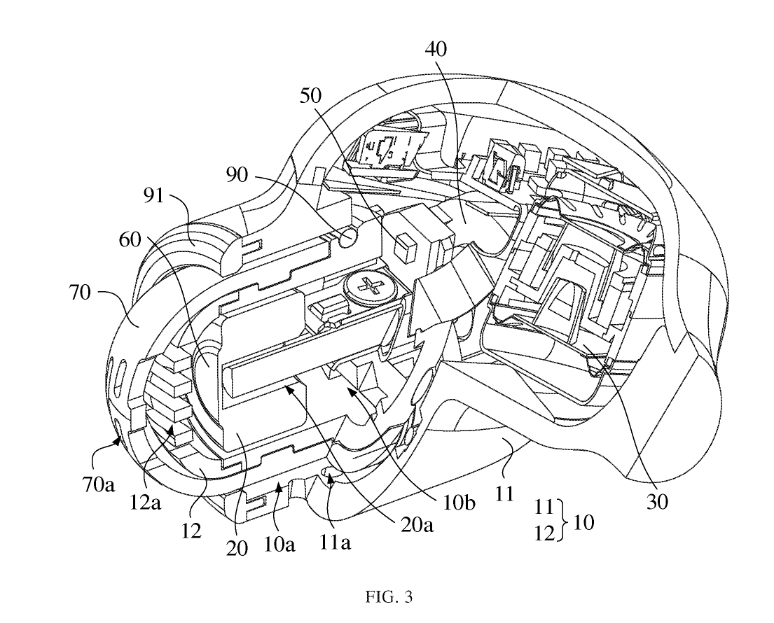

In some embodiments, the open earphone 100 may be an ear-hook earphone. In some embodiments, the wearing part 80 includes an ear-hook configured in an arc shape. The wearing part 80 is connected to a housing 11 (as shown in FIG. 3). The wearing part 80 is configured to be hung between a rear side of the user’s ear and the user’s head. The ear-hook is a flexible long strip structure with deformation ability and can adapt to contour of the ear. This can accommodate ears of different sizes without requiring selection of specific sizes based on the ear size, making it suitable for most people. Therefore, the ear-hook has high versatility.

The wearing part 80 may further include a battery compartment, and the battery compartment is connected to an end of the ear-hook away from the sound-production part 10. A battery that is configured to supply power to a speaker assembly is disposed in the battery compartment. The battery is electrically connected to the speaker through a wire, and the wire passes through the ear-hook. A main control board of the open earphone 100 may be disposed in the sound-production part 10 or in the battery compartment. The battery compartment is disposed between the rear side of the user’s ear and the user’s head during wearing, and the battery compartment has a certain weight. Therefore, a weight distribution of entire open earphone 100 on the ear is relatively balanced, so that wearing the open earphone 100 is more comfortable and stable.

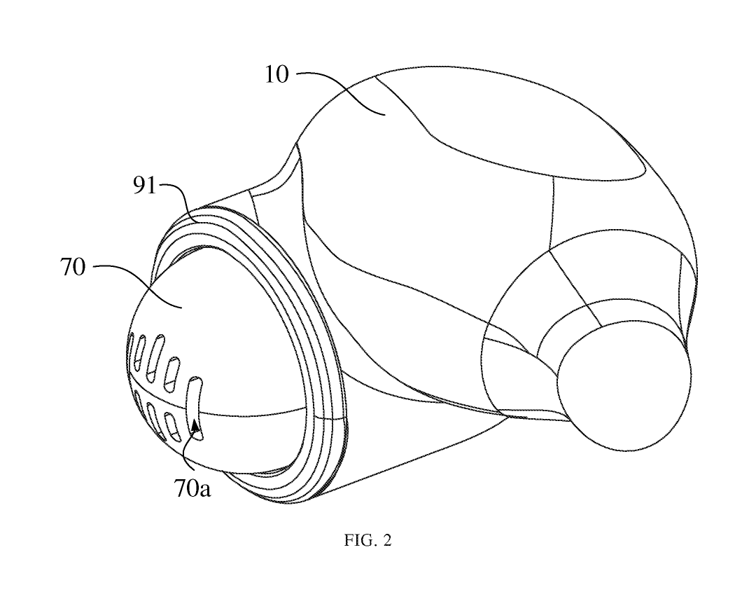

Referring to FIGS. 1 to 3, the sound-production part 10 includes a housing 11 and a sound-emission nozzle 12. The housing 11 is connected to the wearing part 80, and the sound-emission nozzle 12 defines a first sound-emission hole 12a or multiple first sound-emission holes 12a. The first sound-emission holes 12a are defined at a front end of the sound-emission nozzle 12. Herein, the term “front end” refers to an end facing the user’s ear canal opening. The sound-emission nozzle 12 is movably connected to the housing 11. The sound-emission nozzle 12 is able to be telescopically movable relative to the housing 11, so that distances between the first sound-emission holes 12a and the user’s ear canal opening can be adjusted when the open earphone 100 is worn. The sound-emission nozzle 12 is telescopically movable relative to the housing 11, so that the sound-emission nozzle 12 is able to be in a first position, a second position, or a third position between the first position and the second position. When the sound-emission nozzle 12 is in the first position, the first sound-emission holes 12a are spaced apart from the user’s ear canal opening, which may be understood as the open earphone 100 being in an open wearing state in this case. When the sound-emission nozzle 12 is in the second position, the front end (i.e., the part defining the first sound-emission holes 12a) of the sound-emission nozzle 12 is configured to be inserted into the user’s ear canal opening, which may be understood as the open earphone 100 being in an in-ear wearing state in this case. When the sound-emission nozzle 12 is in the third position, the first sound-emission holes 12a may or may not be spaced apart from the user’s ear canal opening, which may be understood as the open earphone 100 being in a semi-in-ear wearing state in this case. Detailed descriptions will be provided below.

In some embodiments, the sound-emission nozzle 12 is in the form of a cover body, and a side of the cover body defines openings. The sound-emission nozzle 12 forms a slidable sleeve connection with the housing 11. When the housing 11 has a trough-shaped structure with an opening, the sound-emission nozzle 12 may be disposed inside the housing 11, or of course, the sound-emission nozzle 12 may also be disposed around the housing 11.

Regarding a manner in which the sound-emission nozzle 12 is telescopically movable relative to the housing 11, it may be a manner of manual adjustment by the user. In some embodiments, the sound-emission nozzle 12 forms the slidable sleeve connection with the housing 11, allowing the user to easily slide the sound-emission nozzle 12 to adjust its position. The slidable sleeve connection can use fewer components, thereby simplifying a manufacturing process. In some embodiments, in order to achieve positioning of the sound-emission nozzle 12, two limit holes spaced apart from each other are defined on the housing 11 along a telescopic direction of the sound-emission nozzle 12, and an elastic protrusion is disposed on the sound-emission nozzle 12. When the sound-emission nozzle 12 is slid to an appropriate position, the elastic protrusion may be inserted or snapped into the limit hole, thereby achieving positioning.

In some embodiments, the sound-emission nozzle 12 is threadedly connected to the housing 11. In some embodiments, an internal thread is disposed on the sound-emission nozzle 12, and an external thread is disposed on the housing 11, so that the sound-emission nozzle 12 is screwed onto the housing 11 through the threads. A threaded connection can provide precise adjustment. The user may adjust the distances between the first sound-emission holes 12a on the sound-emission nozzle 12 and the ear canal opening by rotating, thereby shortening the distances between the first sound-emission holes 12aand the ear canal opening by extending the sound-emission nozzle 12.

In some embodiments, in order to achieve telescopic movement of the sound-emission nozzle 12 relative to the housing 11, a telescopic component may also be disposed between the sound-emission nozzle 12 and the housing 11. In some embodiments, the sound-emission nozzle 12 may be connected to the housing 11 through a bellows structure, so that the telescopic movement of the sound-emission nozzle 12 relative to the housing 11 is achieved through expansion and contraction of the bellows structure.

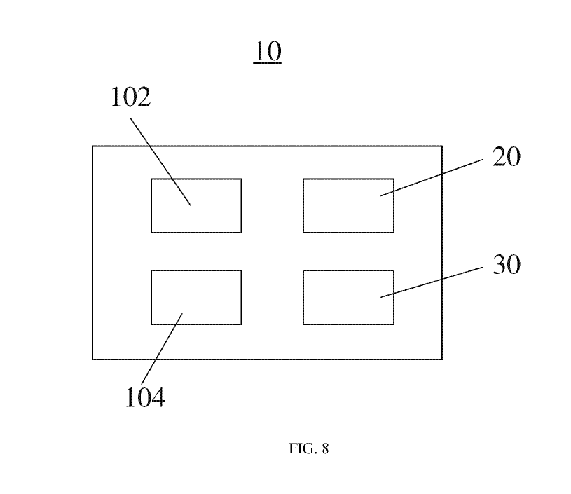

Referring to FIGS. 3 and 8, the open earphone 100 further includes a first speaker 20 and a second speaker 30. The first speaker 20 and the second speaker 30 are components of the open earphone 100 that are configured to convert electrical signals into the sound signals. In some embodiments, the open earphone 100 is an air-conduction earphone, that is, the sound generated by the first speaker 20 and the second speaker 30 is transmitted through the air into the user’s ear canal. In some embodiments, the open earphone 100 is further provided with a battery 102 and a circuit board 104. The battery 102 and the circuit board 104 may be disposed together with the first speaker 20 and the second speaker 30 in the sound-production part 10, or they may be arranged in other forms. In some embodiments, the circuit board 104, the first speaker 20, and the second speaker 30 are disposed together in the sound-production part 10, while the battery 102 is disposed in the wearing part 80, or the battery 102 and the circuit board 104 are disposed in the wearing part 80, or the main control board is disposed in the sound-production part 10 and the battery 102 is disposed in the wearing part 80. These layout forms are all feasible. The battery 102 may be in the form of a rechargeable lithium battery or a disposable dry battery, which is not limited in the present disclosure.

In some embodiments, in the open earphone 100, the sound-emission nozzle 12 is movably connected to the housing 11, enabling telescopic movement of the sound-emission nozzle 12 relative to the housing 11, thereby adjusting the distances between the first sound-emission holes 12a and the user’s ear canal opening. In this way, the open earphone 100 can meet the needs for open wearing, and can also adjust the position of the sound-emission nozzle 12 according to the ear sizes of different users when the users use the open earphone 100, so as to achieve the best wearing and listening effects. Through the design enabling the telescopic movement of the sound-emission nozzle 12 relative to the housing 11, the open earphone 100 can meet the needs of in-ear wearing, which can achieve better sound insulation effect. Therefore, in practical use, when the distance between the first sound-emission holes 12a on the sound-emission nozzle 12 and the user’s ear canal opening is too large, resulting in severe sound leakage and causing the user to feel that the volume of the open earphone 100 is too low, the distances between the first sound-emission holes 12a and the ear canal opening may be shortened by extending the sound-emission nozzle 12, thereby reducing the sound leakage and increasing the volume. When the user feels discomfort because the position of the sound-emission nozzle 12 in an ear canal opening area is unreasonable, the distance between the sound-emission nozzle 12 and the ear canal opening may be increased by retracting the sound-emission nozzle 12. In this way, the open earphone 100 can be suitable for the users with different ear sizes and can achieve good listening effect and good user experience.

The first speaker 20 is disposed inside the sound-emission nozzle 12, and the sound-emission nozzle 12 can protect the first speaker 20. The first speaker 20 emits sound towards the first sound-emission holes 12a. The first sound-emission holes 12amay be in the form of multiple micro-holes arranged in an array. The first speaker 20 may be fixed inside the sound-emission nozzle 12, that is, during the telescopic movement of the sound-emission nozzle 12, the sound-emission nozzle 12 may drive the first speaker 20 to move, and a position of the first speaker 20 in the sound-emission nozzle 12 may not be changed. A front acoustic cavity is defined between the first speaker 20 and a part of an inner wall of the sound-emission nozzle 12, and the front acoustic cavity serves as a front cavity of the first speaker 20. The front cavity of the first speaker 20 is in acoustic communication with the first sound-emission holes 12a.

In order to ensure the comfort during the sound-emission nozzle 12 inserting into the ear, a volume of the first speaker 20 is usually set to a relatively small size. However, this may result in poor sound quality and reduced loudness of the open earphone 100 when the sound-emission nozzle 12 is in a retracted state, which cannot meet the needs of the user.

In order to solve the above problems, this embodiment further includes the second speaker 30, and the second speaker 30 is disposed inside the housing 11 and can be protected by the housing 11. The second speaker 30 is disposed farther away from the first sound-emission hole 12athan the first speaker 20. When the sound-emission nozzle 12 is in a relatively retracted state, the first speaker 20 and the second speaker 30 may be configured to be responsible for different frequency bands. In some embodiments, the first speaker 20 is responsible for high-frequency, while the second speaker 30 is responsible for medium-frequency and low-frequency. Due to shorter wavelength and higher directivity of high-frequency sound, the high-frequency sound is easy to concentrate and propagate at close range. The first speaker 20 responsible for the high-frequency is disposed inside the sound-emission nozzle 12 and close to the first sound-emission holes 12a, which can ensure better directionality and concentration of the high-frequency sound during propagation, reduce diffusion and attenuation of the high-frequency sound in a propagation path, thereby improving clarity and detail performance of the high-frequency sound. In contrast, low-frequency sound and medium-frequency sound have longer wavelengths and stronger diffusion, allowing them to propagate over a wider area. The second speaker 30 responsible for the low-frequency and the medium-frequency is disposed inside the housing 11, and an internal space of the housing 11 may be utilized as a resonant cavity to enhance a resonance effect of the low-frequency sound and the medium-frequency sound, thereby improving the richness and the layering of the sound. Therefore, the setting of the open earphone 100 in this embodiment can better utilize advantages of acoustic principles and structures, so as to improve sound quality performance of the open earphone 100.

Referring to FIG. 3, in order to achieve automatic telescoping of the sound-emission nozzle 12 and reduce the user’s operational burden during wearing, in some embodiments, the open earphone 100 further includes an adjustment mechanism 40. The adjustment mechanism 40 is in transmission connection with the sound-emission nozzle 12. The adjustment mechanism 40 is configured to drive the sound-emission nozzle 12 to telescopically move between the first position and the second position, so that the distance between the sound-emission holes 12 and the user’s ear canal opening can be adjusted when the open earphone 100 is worn.

There are many types of the adjustment mechanisms 40. The adjustment mechanism 40 may drive the sound-emission nozzle 12 to move through a magnetic force, or the adjustment mechanism 40 may drive the sound-emission nozzle 12 to move through a motor, which is not specifically limited here. There are many installation positions for the adjustment mechanism 40. The adjustment mechanism 40 may be installed inside the wearing part 80 or inside the sound-production part 10. In some embodiments, the adjustment mechanism 40 is installed inside the sound-production part 10, which can reduce a distance between the adjustment mechanism 40 and the sound-emission nozzle 12, thereby simplifying a structure of the adjustment mechanism 40.

There are many methods for the user to control the operation of the adjustment mechanism 40. In some embodiments, the open earphone 100 is provided with a control button, a part of the control button extends out of the housing 11, and the user may control the operation of the adjustment mechanism 40 through the control button. In some embodiments, the circuit board 104 is electrically connected to the adjustment mechanism 40, and the circuit board 104 may be connected to the user’s mobile phone via Bluetooth. The user sends a signal to the circuit board 104 through the mobile phone to control the operation of the adjustment mechanism 40. In some embodiments, the open earphone 100 is provided with a pressure sensor, and the user controls the operation of the adjustment mechanism 40 by pressing the pressure sensor. In some embodiments, the open earphone 100 is provided with a remote controller, so that the operation of the adjustment mechanism 40 is directly controlled through the remote controller. In some embodiments, the circuit board 104 is provided with a voice control module and is electrically connected to the adjustment mechanism 40. The voice control module receives the user’s voice command to control the operation of the adjustment mechanism 40, which is not exhaustively listed herein.

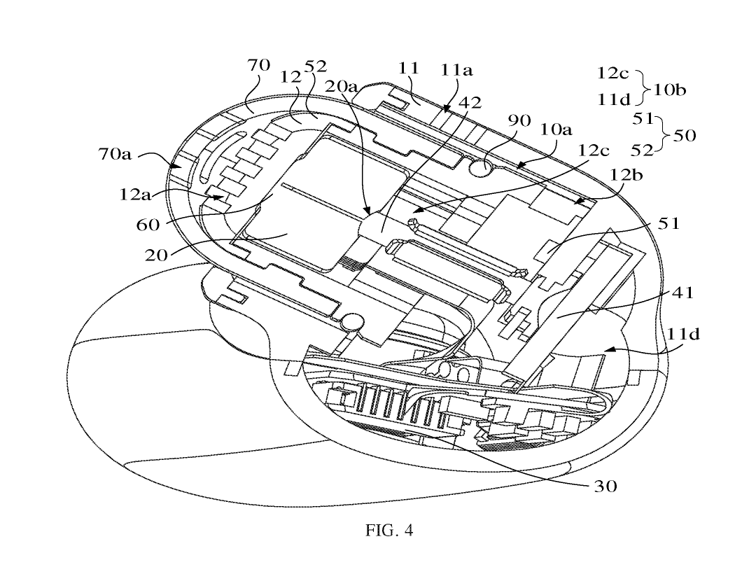

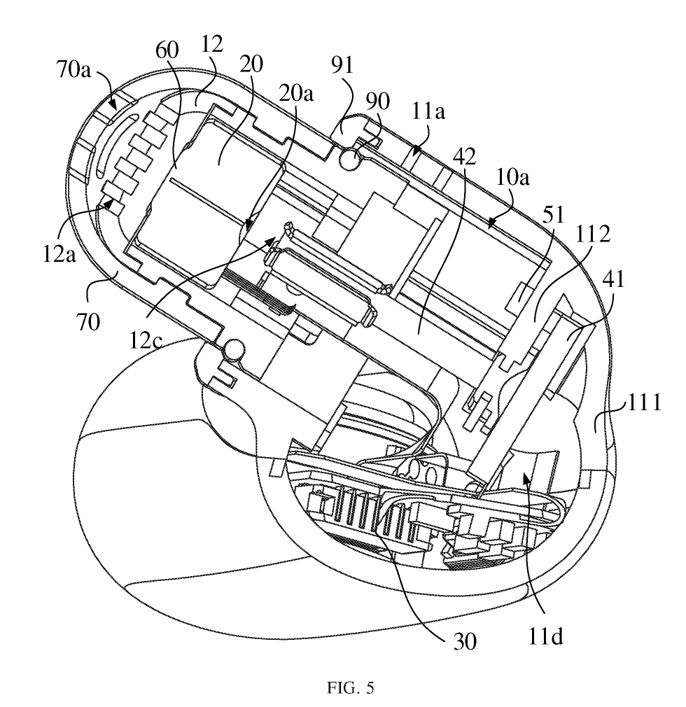

Referring to FIGS. 4 and 5, the adjustment mechanism 40 is configured to drive the sound-emission nozzle 12 to telescopically move between the first position (as shown in FIG. 4) and the second position (as shown in FIG. 5). In the first position, the sound-emission nozzle 12 is retracted relative to the housing 11. In the second position, the sound-emission nozzle 12 extends relative to the housing 11, and the sound-emission nozzle 12 is in contact with the user’s ear canal opening. The first position and the second position of the sound-emission nozzle 12 are limit states of the sound-emission nozzle 12 during the adjustment process. In actual use, the user may also adjust the sound-emission nozzle 12 to be in the third position between the first position and the second position according to their own situation. In this way, when the sound-emission nozzle 12 is disposed in the second position, the sound-emission nozzle 12 is able to be in contact with the user’s ear canal opening, thereby isolating a portion of external sound to achieve a noise reduction effect. Moreover, the open earphone 100 may be switched between an in-ear wearing mode and an open wearing mode, greatly enriching the usage scenarios of the open earphone 100 and making it more convenient to use.

When the sound-emission nozzle 12 is in the first position, the sound-emission nozzle 12 is disposed outside the user’s ear canal opening, and the first sound-emission holes 12a are spaced apart from the ear canal opening, so that the open earphone 100 is switched to the open wearing mode. This allows external environmental sounds to enter and naturally blend with the sound played by the open earphone 100, providing a more open and transparent listening experience while reducing the pressure or discomfort associated with prolonged listening.

In some embodiments, when the sound-emission nozzle 12 is in the second position, the sound-emission nozzle 12 blocks the user’s ear canal opening. In this way, when the sound-emission nozzle 12 is disposed in the second position, the open earphone 100 can effectively isolate external noise, so that the user can enjoy clear sound quality without requiring excessively high volume, thereby protecting hearing. Moreover, it can create a more immersive auditory experience for the user, such as providing excellent bass response and detail resolution, thereby meeting the needs of music enthusiasts.

When the sound-emission nozzle 12 is in the third position, the user may adjust the sound-emission nozzle 12 to be in the third position according to their own needs and wearing comfort. In the third position, the sound-emission nozzle 12 is neither completely in contact with the ear canal opening, nor completely disposed outside the ear canal opening. The sound-emission nozzle 12 is in an intermediate state. This design allows the user to flexibly adjust the position of the sound-emission nozzle 12 according to different usage scenarios and preferences, so as to achieve better listening experience and better wearing comfort.

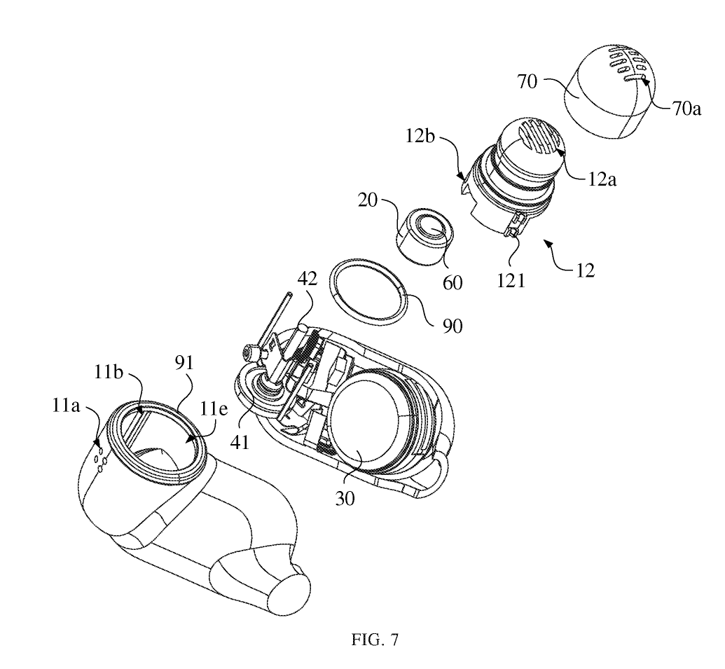

Referring to FIG. 7, in order to avoid relative torsion between the sound-emission nozzle 12 and the housing 11 during the telescopic movement of the sound-emission nozzle 12, in some embodiments, a guiding structure is further disposed between the sound-emission nozzle 12 and the housing 11. The guiding structure is configured to prevent circumferential torsion between the sound-emission nozzle 12 and the housing 11 during the telescoping process. In some embodiments, as shown in the FIG. 7, the guiding structure may include a guiding groove 11band a guiding block 121. The guiding groove 11b may be defined on the sound-emission nozzle 12 or on the housing 11, and extend in the telescopic direction of the sound-emission nozzle 12. The guiding block 121 slides along the guiding groove 11b. That is, in some embodiments, the setting positions of the guiding groove 11b and the guiding block 121 may be interchangeable between the sound-emission nozzle 12 and the housing 11. By disposing the guiding structure, the relative torsion between the sound-emission nozzle 12 and the housing 11 is avoided. Therefore, when a cross-sectional shape of the sound-emission nozzle 12 and a cross-sectional shape of the housing 11 are designed to be non-circular, interference between the sound-emission nozzle 12 and the housing 11 can be effectively avoided, and structure deformation of the sound-emission nozzle 12 can be avoided.

In some embodiments, the guiding structure may be omitted, the relative torsion between the sound-emission nozzle 12 and the housing 11 may be avoided through shape setting of the housing 11 and the sound-emission nozzle 12. In some embodiments, cross-sectional profile shapes of both the housing 11 and the sound-emission nozzle 12 may be set as runway shapes, polygons, etc. In this way, mutually sliding cooperating flat surfaces are disposed between the housing 11 and the sound-emission nozzle 12, thereby preventing torsion of the sound-emission nozzle 12 relative to the housing 11 during the telescoping process.

Referring to FIG. 7, in some embodiments, the adjustment mechanism 40 includes a piezoelectric vibrator 41 and a friction member 42. The friction member 42 is disposed on an output terminal of the piezoelectric vibrator 41. The friction member 42 is in driving engagement with the sound-emission nozzle 12, so that the piezoelectric vibrator 41 is able to drive the friction member 42 to move, thereby driving the sound-emission nozzle 12 to move along the telescopic direction. The ultrasonic vibration generated by the piezoelectric effect causes the friction member 42 fixed on the piezoelectric vibrator 41 to produce synchronous high-frequency vibration. This vibration can drive the sound-emission nozzle 12 to move in a straight line through friction between the friction member 42 and the sound-emission nozzle 12. By adjusting driving waveform, the sound-emission nozzle 12 can move along a retraction direction. This structural form has the advantages of simple structure and fewer components.

The driving engagement between the friction member 42 and the sound-emission nozzle 12 may be achieved by disposing a clamping part on the sound-emission nozzle 12 and allowing the clamping part to clamp the friction member 42. The driving engagement between the friction member 42 and the sound-emission nozzle 12 may be achieved by tightly contacting the sound-emission nozzle 12 and the friction member 42 through electromagnetic suction. The driving engagement between the friction member 42 and the sound-emission nozzle 12 may be achieved by pressing the sound-emission nozzle 12 against the friction member 42 due to its own gravity, which is not exhaustively listed herein.

In order to achieve a more compact arrangement of the friction member 42 inside the sound-production part 10, the first speaker 20 defines a guiding hole 20a, and a part of the friction member 42 may be configured to pass through the guiding hole 20a, which can more efficiently utilize a space inside the sound-production part 10. This design reduces mutual interference between components, so that an overall structure of the open earphone 100 is more compact and smaller in size, thereby improving portability and wearing comfort.

In some embodiments, the adjustment mechanism 40 further includes a clamping member, an end of the clamping member is fixedly connected to the sound-emission nozzle 12, and another end of the clamping member is provided with an elastic clamping part. The elastic clamping part is configured to clamp a peripheral wall of the friction member 42. In this way, the elastic clamping part may clamp the friction member 42, so that the driving engagement between the friction member 42 and the sound-emission nozzle 12 can be more stable, thereby better driving the movement of the sound-emission nozzle 12 through the adjustment mechanism 40.

In some embodiments, the friction member 42 is made of a carbon fiber material. The carbon fiber material has high hardness. In an ultrasonic linear motion system driven by a piezoelectric ceramic, the friction member 42 needs to frequently contact and generate friction with a sliding block. The high hardness of the carbon fiber enables it to withstand this frictional effect, thereby reducing its own wear. During long-term linear motion, compared to some soft materials, a shape and a size of the friction member 42 made of the carbon fiber material can better maintain stability, thereby maintaining stable friction performance. The good wear resistance of the carbon fiber material can extend service life of the friction member 42. Moreover, using the friction member 42 made of the carbon fiber can reduce replacement frequency of the component, thereby lowering maintenance costs.

Referring to FIGS. 5 and 7, in some embodiments, the friction member 42 is a carbon rod, and the carbon rod has an elongated configuration and extends along a length direction of the sound-emission nozzle 12. A cross-sectional diameter of the carbon rod is defined as a, while a diameter of the guiding hole 20a is defined as b, and b satisfies the conditions: (0.5 mm + a) ≤ b ≤ (1.5 mm + a). That is, the diameter of the guiding hole 20ais greater than the cross-sectional diameter of the carbon rod by 0.5 mm to 1.5 mm, so that an appropriate gap is defined between the carbon rod and the guiding hole 20a. This gap is not too small, so as to avoid excessive frictional force between the carbon rod and a wall of the guiding hole 20a. When the gap is too small, it may increase resistance during movement of the carbon rod, hindering smooth sliding of the carbon rod and potentially causing jamming or seizure. The excessive friction may accelerate the wear of the carbon rod. When the gap is too small, such as less than 0.5 mm, it may also cause the expansion and retraction function of the sound-emission nozzle 12 to malfunction. When the gap is too large, such as greater than 1.5 mm, since the adjustment mechanism 40 needs to rely on the carbon rod to transmit a force for moving the sound-emission nozzle 12, such an excessive gap may adversely affect force transmission, so that the sound-emission nozzle 12 fails to move or stop as intended.

In some embodiments, the housing 11 is disposed around the sound-emission nozzle 12, and the circuit board 104 is disposed inside the housing 11. In the second position, the circuit board 104 controls the first speaker 20 to independently operate, that is, in this case, the first speaker 20 is responsible for a full frequency band. In the second position, the first sound-emission holes 12aare defined on the front end of the sound-emission nozzle 12, the sound-emission nozzle 12 extends outward, and the part of the sound-emission nozzle 12 with the first sound-emission holes 12a extends into the ear canal opening, so that the sound can be transmitted more directly into the ear canal. A space inside the ear canal is relatively closed, and reflection and standing wave effects of the sound are significantly reduced, reducing loss and diffusion of the sound during propagation, thereby providing clearer and more concentrated sound quality performance. The clarity and detail of the high-frequency sound are further improved, while ensuring transmission efficiency of the medium-frequency sound and the low-frequency sound.

On the basis of optimizing sound quality performance, the second speaker 30 may not operate, which can reduce power consumption of the open earphone 100 in the second position. The power required to drive only one speaker is significantly lower than the power required to simultaneously drive two speakers, thereby extending battery life of the open earphone 100.

In the first position, the first sound-emission holes 12a are spaced apart from the user’s ear canal opening. Since the propagation path of the sound in the space is more complex, reflection and standing wave effects are easily generated. In this case, it is difficult for a single speaker to simultaneously meet the sound quality requirements for the high-frequency, the medium-frequency, and the low-frequency. Therefore, the circuit board 104 is configured to control both the first speaker 20 and the second speaker 30 to simultaneously operate when the sound-emission nozzle 12 is in the first position. The first speaker 20 and the second speaker 30 may be configured to be responsible for different frequency bands, such as the first speaker 20 being responsible for the high-frequency, and the second speaker 30 being responsible for the medium-frequency and the low-frequency. This can provide a more balanced sound quality performance, especially in terms of detail and layering in the high-frequency, the medium-frequency, and the low-frequency. By assigning the high-frequency, the medium-frequency, and the low-frequency to different speakers for processing, the advantages of each speaker can be fully utilized. The first speaker 20 is disposed inside the sound-emission nozzle 12. Due to limited space, the first speaker 20 usually has a relatively small size and is better suited for processing a high-frequency signal. The second speaker 30 is disposed inside the housing 11, and the second speaker 30 may be configured to have a larger volume than the first speaker 20, so that the second speaker 30 can process a medium-frequency signal and a low-frequency signal through a larger diaphragm and a stronger magnetic circuit system.

An operating state of the first speaker 20 and an operating state of the second speaker 30 when the sound-emission nozzle 12 is in the third position, may be the same as the operating state of the first speaker 20 and the operating state of the second speaker 30 when the sound-emission nozzle 12 is in the second position. The operating state of the first speaker 20 and the operating state of the second speaker 30 may be appropriately adjusted based on operating data of the first speaker 20 and the second speaker 30 in the second position.

As shown in FIG. 5, in order to enable the second speaker 30 to more effectively output the medium-frequency sound and the low-frequency sound when the open earphone 100 is in the first position, a sound-emission channel 10a may be defined between the sound-emission nozzle 12 and the housing 11. The sound-emission channel 10ais a narrow-slit channel, and the narrow-slit channel may be regarded as a special acoustic duct. The acoustic duct may be configured to guide and adjust the sound. Especially in the low-frequency band, the duct may act as the resonant cavity, enhancing the propagation efficiency of the low-frequency sound. By reasonably designing a length and a width of the narrow-slit, it can be ensured that the low-frequency sound is not lost due to spatial limitation during propagation, instead, the low-frequency sound is actually enhanced through the resonance effects. A side wall of the sound-emission nozzle 12 defines a sound-guiding hole 12b, and the sound-guiding hole 12b is in acoustic communication with the space inside the sound-emission nozzle 12. A peripheral wall of the housing 11 defines a second sound-emission hole 11a, and multiple second sound-emission holes 11a may be arranged in a micro-hole array. The sound-emission channel 10ais in acoustic communication with the sound-guiding hole 12b and the second sound-emission hole 11a.

The second sound-emission hole 11a is disposed closer to the first sound-emission hole 12a than the sound-guiding hole 12b, so that the propagation paths and time differences of the sounds emitted by two sound sources (the first speaker 20 and the second speaker 30) in the ear canal are smaller. That is, the high-frequency sound (output by the first speaker 20 through the first sound-emission hole 12a) and the medium-frequency sound and the low-frequency sound (output by the second speaker 30 through the second sound-emission hole 11a) can blend more effectively in the ear canal. This layout reduces sound separation caused by excessive distance between the sound sources, improving integrity and layering of the sound quality. Consequently, the sense of separation when the sound reaches the ear canal is reduced, making the sound perceived by the user more natural and unified.

The sound-guiding hole 12bis disposed closer to the second speaker 30 than the first speaker 20, ensuring that the propagation paths for the medium-frequency sound and the low-frequency sound from the second speaker 30 to the second sound-emission hole 11a are shorter and more direct. This design reduces energy loss during sound propagation, ensuring that the medium-frequency sound and the low-frequency sound can be transmitted more efficiently to the ear canal. The sound-guiding hole 12bthat is close to the second speaker 30 can better cooperate with the sound-emission characteristics of the second speaker 30, thereby enhancing the resonance effect of the low-frequency sound. This resonance can enhance the depth and the intensity of the low-frequency sound, making the sound quality more full-bodied. The interference of the high-frequency sound generated by the first speaker 20 on the medium-frequency sound and the low-frequency sound can be reduced, further improving the purity of the bass.

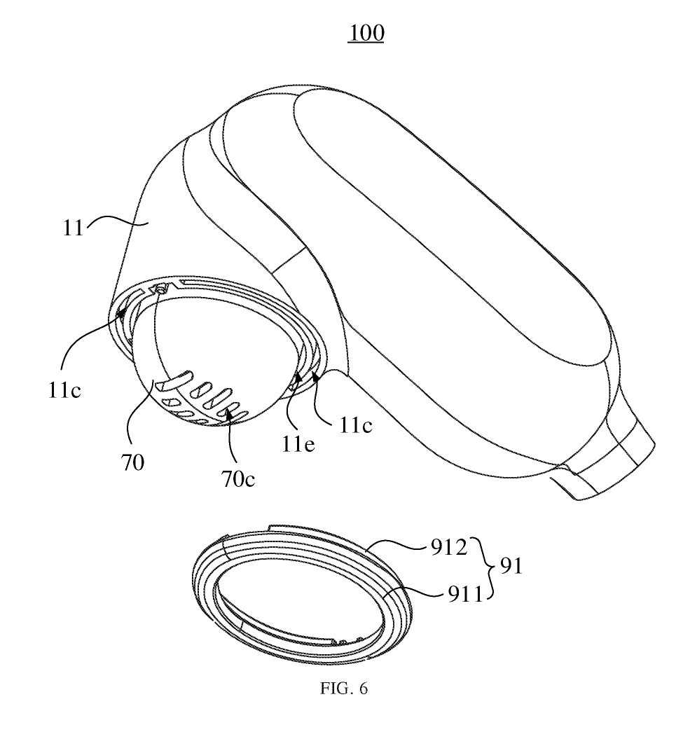

As shown in FIGS. 5 and 6, an end of the housing 11 away from the wearing part 80 defines an installation port 11e, and the sound-emission nozzle 12 is movably disposed in the installation port 11e and may be telescopically movable relative to the housing 11. In order to reduce the sound leakage from the second speaker 30 and improve the optimized acoustic performance, the open earphone 100 further includes an elastic sealing member 91. The elastic sealing member 91 is disposed in the installation port 11e and elastically abuts against an outer wall of the sound-emission nozzle 12. In some embodiments, the elastic sealing member 91 is configured in an annular shape and surrounds periphery of the sound-emission nozzle 12, so that the elastic sealing member 91 elastically abuts against the outer wall of the sound-emission nozzle 12. The elastic sealing member 91 is configured to seal a gap between the installation port 11e of the housing 11 and the sound-emission nozzle 12. This sealing design can significantly reduce the sound leakage from the narrow-slit on the front end, ensuring that the sound from the second speaker 30 is mainly transmitted through the preset second sound-emission hole 11a. Through the sealing effect of the elastic sealing member 91, the resonance effect of the sound-emission channel 10a (the narrow-slit channel) can be better utilized. As the special acoustic duct, the narrow-slit channel is capable of guiding and adjusting the sound. Especially in the low-frequency band, the duct can act as the resonant cavity, enhancing the propagation efficiency of the low-frequency sound.

The design of the elastic sealing member 91 enables the earphones to resist intrusion of a liquid such as sweat, rainwater, as well as dust when the earphones are used outdoors or during exercise, thereby protecting the first speaker 20 and the second speaker 30 inside the sound-production part 10 from damage and extending the service life of the earphones.

The elastic sealing member 91 may be made of a material with high elasticity and flexibility, which can seal the gap between the housing 11 and the sound-emission nozzle 12 without affecting the telescopic movement of the sound-emission nozzle 12 relative to the housing 11. This ensures good sealing performance while effectively reducing the sound leakage from the narrow-slit on the front end.

In some embodiments, the elastic sealing member 91 includes an annular base 911 and multiple insertion pins 912. The insertion pins 912 are connected to a side of the annular base 911 facing the housing 11. An end face of the housing 11 away from the wearing part 80 defines multiple insertion grooves 11c. The multiple insertion grooves 11ccorrespond one-to-one with the multiple insertion pins 912. Each insertion pin 912 may be inserted into a corresponding insertion groove 11c, so as to limit the position of the elastic sealing member 91. The multiple insertion pins 912 are spaced apart and disposed along the circumference of the annular base 911, so that the elastic sealing member 91 is tightly connected to the housing 11, thereby ensuring positional stability of the elastic sealing member 91 and preventing displacement of the elastic sealing member 91 with movement of the sound-emission nozzle 12.

The sound-guiding hole 12bis a transmission channel for the sound from the second speaker 30 to the second sound-emission hole 11a. The sound-guiding hole 12b may guide the sound from the second speaker 30 to an independent sound-emission channel 10a, avoiding direct interference with the first speaker 20 (the high-frequency sound). In the first position, along the extension path of the sound-emission channel 10a, the sound-emission channel 10ais in acoustic communication with the sound-guiding hole 12b and the second sound-emission hole 11a. The second sound-emission hole 11ais a final output port of the sound from the second speaker 30.

As shown in FIGS. 3, 4, and 5, in some embodiments, the first speaker 20 divides the space inside the sound-emission nozzle 12 to form a first acoustic cavity 12c that is disposed on a rear side of the first speaker 20. The first speaker 20 may be disposed in a position inside the sound-emission nozzle 12 and close to a front side of the sound-emission nozzle 12. The second speaker 30 divides the space inside the housing 11 to form a second acoustic cavity 11d that is disposed on a front side of the second speaker 30. The second speaker 30 may be disposed in a position inside the housing 11 and close to a rear side of the housing 11. The first acoustic cavity 12cand the second acoustic cavity 11d are in acoustic communication with each other and jointly form a larger coupling acoustic cavity 10b. Due to the large volume of the coupling acoustic cavity 10b, a diaphragm of the first speaker 20 may not excessively compress air molecules during vibration and operation of the diaphragm of the first speaker 20, thereby reducing an air pressure variation during the vibration of the diaphragm of the first speaker 20. The coupling acoustic cavity 10b is able to provide a more stable vibration environment for the diaphragm of the first speaker 20, reducing vibration instability caused by the air pressure variation.

The coupling acoustic cavity 10bis in acoustic communication with the sound-guiding hole 12b, and the sound-guiding hole 12b is in acoustic communication with the second sound-emission hole 11a through the sound-emission channel 10a. When the sound-emission nozzle 12 is in the first position, the coupling acoustic cavity 10b provides a larger acoustic volume for the second speaker 30, increasing the volume of low-frequency resonance and providing a resonance space for the medium-frequency sound and the low-frequency sound. This resonance space can enhance the propagation efficiency of the low-frequency sound, increase the depth and the intensity of the low-frequency sound, and make the sound quality more full-bodied. The coupling acoustic cavity 10bseparates the sound of the second speaker 30 from the sound of the first speaker 20, reducing the mutual interference between the high-frequency sound and the medium-frequency sound, and reducing mutual interference between the high-frequency sound and the low-frequency sound. This frequency division design can better leverage the advantages of each speaker unit, enhancing the clarity and the layering of the sound quality.

The coupling acoustic cavity 10b is in acoustic communication with the second sound-emission hole 11a through the sound-guiding hole 12b, ensuring that the sound of the second speaker 30 can be transmitted more directly to the second sound-emission hole 11a, so that the sense of separation when the sound reaches the ear canal is reduced, making the sound perceived by the user more natural and unified.

When the sound-emission nozzle 12 is in the second position, the second speaker 30 does not operate. The second sound-emission hole 11athat is in acoustic communication with the coupling acoustic cavity 10b may be used as a pressure relief hole for the first speaker 20, which helps balance the air pressure inside the coupling acoustic cavity 10b and avoid affecting the vibration performance of the first speaker 20 due to excessive air pressure. By utilizing the second sound-emission hole 11aas the pressure relief hole, a dedicated pressure relief hole may be omitted, thereby simplifying the structure of the open earphone 100.

Referring to FIGS. 3, 4, and 5, in order to further improve the listening experience of the user using the open earphone 100 of this embodiment, the open earphone 100 further includes a noise-reduction microphone 60. The noise-reduction microphone 60 can capture external ambient noise and generate sound waves with opposite phases through a built-in noise-reduction algorithm. These sound waves with opposite phases can cancel out the noise waves, thereby reducing the noise entering the ears, improving the clarity of listening to music and the quality of voice communication. The noise-reduction microphone 60 may be disposed between the first speaker 20 and the first sound-emission hole 12a, which can more accurately capture the noise inside the ear canal. In this position, the noise signal captured by the microphone and the signal emitted by the speaker can be more easily aligned in phase, which is crucial for achieving effective active noise-reduction.

Referring to FIGS. 3, 4, and 5, in order to ensure the proper movement of the sound-emission nozzle 12 between the first position and second position, the open earphone 100 further includes a detection assembly 50, and the detection assembly 50 is electrically connected to the circuit board 104. The detection assembly 50 is configured to detect position information regarding the telescopic movement of the sound-emission nozzle 12 relative to the housing 11 and send the position information to the circuit board 104. That is, the detection assembly 50 is configured to detect the position of the sound-emission nozzle 12.

The circuit board 104 is configured to control both the first speaker 20 and the second speaker 30 to operate simultaneously when the circuit board 104 receives the position information from the detection assembly 50 indicating that the sound-emission nozzle 12 is in the first position. The circuit board 104 is configured to control the first speaker 20 to operate alone when the circuit board 104 receives the position information from the detection assembly 50 indicating that the sound-emission nozzle 12 is in the second position. The received detection signals are processed through the circuit board 104, and the operating modes of the speakers are able to be adjusted according to the signals, this design reflects the intelligence of the device. It can automatically adjust the audio output according to the user’s actual usage scenario, reducing the trouble of manual adjustment for the user.

In some embodiments, in the first position, the circuit board 104 may be configured to allocate the high-frequency signal to the first speaker 20, and configured to allocate the medium-frequency signal and the low-frequency signal to the second speaker 30. Due to the high energy and short wavelength of the high-frequency sound, the high-frequency sound is easy to rapidly attenuate in an open space. Therefore, the high-frequency signal requires a more efficient propagation method. The high-frequency signal propagates through the first speaker 20, which can better maintain high-frequency clarity. The medium-frequency signal and the low-frequency signal propagate through the second speaker 30, which can achieve better diffusion in the open space. In the second position, the circuit board 104 may be configured to allocate the high-frequency signal, the medium-frequency signal, and the low-frequency signal all to the first speaker 20. In the second position, the sound-emission nozzle 12 is close to the ear canal, resulting in a shorter sound propagation path. The ear canal itself provides a certain resonance effect for the sound propagation. Allocating signals of all frequency bands to the first speaker 20 can ensure concentration and consistency of the sound, reduce the sound leakage, and improve concentration and immersion of the sound quality.

The low-frequency ranges from 20 Hz to 200 Hz, the medium-frequency ranges from 200 Hz to 2 kHz, and the high-frequency ranges from 2 kHz to 20 kHz. In the design of the open earphone 100, based on the characteristics of these frequency bands, the first speaker 20 and the second speaker 30 are designed to specifically process the signals in specific frequency bands, so as to achieve the optimal sound quality performance of the open earphone 100 in the first position and the second position.

In some embodiments, the detection assembly 50 includes a detection member 51 and a triggering member 52. The detection member 51 is disposed in the housing 11, and the triggering member 52 is disposed on the sound-emission nozzle 12. The number of the detection member 51 may be one or two. When the number of the detection member 51 is one, the position of the sound-emission nozzle 12 may be determined by the signal change of the detection member 51. When there are two detection members 51, the two detection members 51 may correspond to the first position and the second position, respectively, so that the position of the sound-emission nozzle 12 may be determined by obtaining signals of different detection members 51. In some embodiments, when the sound-emission nozzle 12 is in the first position, the corresponding detection member 51 couples with a signal of the triggering member 52 to generate a detection signal, while when the sound-emission nozzle 12 is in the second position, another corresponding detection member 51 couples with the signal of the triggering member 52 to generate another detection signal.

The user may select the wearing state of the open earphone 100 through a physical button disposed on the earphone or a virtual button on a control panel, thereby automatically adjusting the amount of the telescopic movement of the sound-emission nozzle 12 relative to the housing 11. In some embodiments, when the user selects the in-ear wearing mode, the sound-emission nozzle 12 may automatically extend relative to the housing 11 to a preset second position. When the user selects the open wearing mode, the sound-emission nozzle 12 may automatically retract to a preset first position. During this process, the detection member 51 and the triggering member 52 of the detection assembly 50 are configured to provide feedback regarding whether the telescopic position of the sound-emission nozzle 12 has reached the intended position, ensuring that the telescopic movement of the sound-emission nozzle 12 is accurately completed.

In some embodiments, the open earphone 100 further includes a digital signal processor (DSP) (not labeled in figures) and multiple power amplifiers (PA) (not labeled in figures). The DSP may be integrated into a main control chip of the earphone. The open earphone 100 is provided with a first audio parameter and a second audio parameter, the first audio parameter corresponds to the speaker data in the first position, and the second audio parameter corresponds to the speaker data in the second position.

In some embodiments, the DSP is configured to adjust the operating modes of the first speaker 20 and the second speaker 30 based on the position signal generated by the detection assembly 50. The PA is configured to amplify the audio signal to sufficient power, so as to drive the corresponding speaker to produce the sound. After receiving the detection signal of the first position, the DSP determines that the sound-emission nozzle 12 is in the first position. The DSP divides the audio signals into two parts: one part is the high-frequency signal, and the other part is the medium-frequency signal and the low-frequency signal; and allocates them to the first speaker 20 and the second speaker 30, respectively. The corresponding PA amplifies the audio signal to the sufficient power, so as to drive two speakers to produce the sound simultaneously. After receiving the detection signal of the second position, the DSP determines that the sound-emission nozzle 12 is in the second position. The DSP allocates the audio signal to the first speaker 20 through the second audio parameter, and amplifies the audio signal to the sufficient power through the PA corresponding to the first speaker 20, so as to drive the first speaker 20 to produce the sound.

In some embodiments, the DSP directly obtains the selection made by the user through the physical button or the control panel, so that the allocated audio signals are able to be adjusted, so as to switch the operating modes of the first speaker 20 and the second speaker 30. In some embodiments, when the DSP receives a signal indicating that the user selects the in-ear wearing mode, the sound-emission nozzle 12 automatically extends to the second position, while the triggering member 52 and the detection member 51 providing the feedback that the telescopic position has reached the intended position. The DSP subsequently allocates the audio signal to the first speaker 20 according to the second audio parameter, and the PA corresponding to the first speaker 20 amplifies the audio signal to the sufficient power, so as to drive the first speaker 20 to produce the sound. In this case, the DSP shuts off the audio signal of the second speaker 30 through a control logic, ensuring that only the first speaker 20 operates, so as to optimize the sound quality and noise-reduction effect in the in-ear wearing state. On the contrary, when the DSP receives a signal indicating that the user selects the open wearing mode, the sound-emission nozzle 12 automatically retracts to the first position. The DSP divides the audio signals into two parts based on the first audio parameter, one part is the high-frequency signal, and the other part is the medium-frequency signal and the low-frequency signal; and allocates them to the first speaker 20 and the second speaker 30, respectively. The corresponding PA amplifies the audio signal to the sufficient power, so as to drive two speakers to produce the sound simultaneously, providing optimal sound quality performance in the open wearing state.

In some embodiments, the triggering member 52 is fixedly connected to the sound-emission nozzle 12 or the first speaker 20. That is, the triggering member 52 may be a separate component that may be independently designed and optimized according to specific needs and subsequently connected to the sound-emission nozzle 12 or the first speaker 20. When the triggering member 52 is damaged or needs to be upgraded, the triggering member 52 may be replaced separately without replacing the entire sound-emission nozzle 12 or speaker, reducing maintenance costs.

In some embodiments, a part of the sound-emission nozzle 12 or a part of the first speaker 20 is configured as the triggering member 52, reducing the number of components inside the open earphone 100, thereby optimizing space utilization and making the earphone more compact. Therefore, the triggering member 52 requires no additional connection to the sound-emission nozzle 12 or the first speaker 20, reducing the connection points between components, enhancing the stability of the overall structure, and reducing the risk of failure caused by loose components.

In some embodiments, the first speaker 20 includes an auxiliary system, a vibration system, and a magnetic circuit system. The vibration system is disposed in the auxiliary system, and the auxiliary system may include an outer shell and a front shell of the first speaker 20. The outer shell and the front shell cooperate to form a protective frame. The vibration system is configured for vibration and sound-production. The vibration system includes the diaphragm and a voice coil, and the voice coil is configured to drive the diaphragm to vibrate. The magnetic circuit system is disposed in the auxiliary system. The magnetic circuit system may include a basket, a magnet, and a pole plate. The magnetic circuit system is able to form a stable magnetic field, and the voice coil may be subjected to an electromagnetic force in the magnetic field, thereby driving the diaphragm to vibrate and produce the sound. That is, the magnetic circuit system is configured to provide a driving force for the vibration system.

Seen from the above content, in some embodiments, the magnetic circuit system may be configured as the triggering member 52, thereby eliminating the need for a separately provided triggering member 52.

As shown in FIG. 5, the housing 11 includes a housing body 111 and a bracket 112. The housing body 111 defines a receiving cavity, and the bracket 112 is disposed in the receiving cavity. Two sides of the bracket 112 respectively define the receiving cavity and a sliding cavity. The second speaker 30 is received in the receiving cavity. The detection member 51 is disposed on a side of the receiving cavity close to the sliding cavity. The triggering member 52 is connected to the detection member 51 and extends into the sliding cavity. The sound-emission nozzle 12 is slidably disposed in the sliding cavity, and the detection member 51 is disposed on the bracket 112, so that the detection member 51 can monitor the position change of the sound-emission nozzle 12 in real time, ensuring the accuracy of position detection.

In some embodiments, the triggering member 52 may be the magnet, while the detection member 51 may be a Hall sensor. The triggering member (the magnet) 52 may be fixed on the sound-emission nozzle 12 and move with the telescopic movement of the sound-emission nozzle 12. The magnet generates a stable magnetic field. During the sound nozzle 12 moving, a distance between the magnet and the Hall sensor changes, and magnetic field strength also changes accordingly. The Hall sensor is a magnetic-sensitive element based on the Hall effect. during the magnetic field (generated by the magnet) approaching the Hall sensor, the charge carriers inside the sensor are subjected to a Lorentz force, resulting in generation of a potential difference. This potential difference (a Hall voltage) is directly proportional to the magnetic field strength. Therefore, presence and intensity changes of the magnetic field can be perceived by detecting changes in the Hall voltage. In some embodiments, the detection assembly 50 may also adopt a form such as a micro-switch or a photoelectric switch, etc., which is not limited in the present disclosure.

Referring to FIGS. 6 and 7, in some embodiments, the ear cap 70 is detachably connected to the sound-emission nozzle 12, and the ear cap 70 is disposed around the sound-emission nozzle 12. The ear cap 70 defines a sound-production hole 70athat is in acoustic communication with the first sound-emission hole 12a. The ear cap 70 may be made of a flexible material, such as a silicone material. Based on a structural form in which the sound-emission nozzle 12 is capable of telescopic movement relative to the housing 11, the user may choose a more suitable ear cap 70 by disassembling and reassembling the ear cap 70. In some embodiments, the distance between the sound-emission hole and the ear canal opening may be shortened by extending the sound-emission nozzle 12. When the sound-emission nozzle 12 has reached its maximum extension limit while the sound leakage still remains significant, the ear cap 70 may be disassembled and replaced with a larger ear cap 70. The larger ear cap 70 may achieve a tighter seal against the ear canal opening, more effectively isolate external noise, achieve better noise-reduction effect, thereby improving the listening experience. The distance between the sound-emission nozzle 12 and the ear canal opening may be increased by retracting the sound-emission nozzle 12. When the user still feels discomfort due to improper positioning of the sound-emission nozzle 12 in the ear canal area, the ear cap 70 may be disassembled and replaced with a smaller ear cap 70, so as to further increase the distance between the ear cap 70 and the ear canal opening, improving the adaptability of the open earphone 100 and providing the user with a more comfortable user experience. The above settings enable the open earphone 100 to be suitable for the users with different ear sizes, achieving good listening and usage effects, thereby meeting the usage needs of different users.

In addition, the detachable connection between the ear cap 70 and the sound-emission nozzle 12 allows the ear cap 70 to be easily removed, thereby cleaning or replacing the ear cap 70. Especially for the user who often sweats or uses the open earphone 100 in humid environments, this design can help them maintain the hygiene of the ear cap 70. Moreover, the detachable connection between the ear cap 70 and the sound-emission nozzle 12 facilitates the replacements of the ear caps 70 with various sizes or types. The user can choose the appropriate ear cap 70 according to personal preference or the ear size, improving wearing comfort. Moreover, it is also convenient for the user to replace the ear cap 70 according to different usage scenarios.

In actual use, after telescopically adjusting the sound-emission nozzle 12, the user may want the sound-emission nozzle 12 to remain in an adjusted position, so as to adapt to various motion scenarios. This may be achieved through the frictional force between the sound-emission nozzle 12 and the housing 11. In some embodiments, the sound-emission nozzle 12 and the housing 11 may be in an interference fit, with a certain compressive deformation existing at a contact wall surface between them. In some embodiments, a wall of the sound-emission nozzle 12 that is in contact with the housing 11 may be made of a soft rubber material. In some embodiments, the sealing structure 90 may also be disposed between the sound-emission nozzle 12 and the housing 11. That is, the sealing structure 90 itself generates elastic deformation and resistance, so as to prevent loosening of the sound-emission nozzle 12 relative to the housing 11. The sealing structure 90 may be a damping ring or a damping sheet made of silicone or similar material, etc.

In some embodiments, referring to FIG. 7, the sealing structure 90 of the open earphone 100 may be a sealing ring. The sealing ring may be made of a material with damping properties, such as silicone or rubber, etc. The sealing ring is disposed on one of the housing 11 and the sound-emission nozzle 12, and the sealing ring seals against or is in contact with the other one of the housing 11 and the sound-emission nozzle 12. In some embodiments, the sound-emission nozzle 12 is disposed inside the housing 11, and the sealing ring is sandwiched between the housing 11 and an outer wall surface of the sound-emission nozzle 12. A fixing groove may be defined on the sound-emission nozzle 12 or the housing 11, and the sealing ring is embedded and fixed in the fixing groove. The setting of the sealing ring also helps to reduce the resonance amplitude generated by the mechanical structures of the sound-emission nozzle 12 and the housing 11 during sound transmission, thereby avoiding structural damage caused by vibration stress reaching its limit. The sealing ring is sandwiched between the housing 11 and the outer wall of the sound-emission nozzle 12. Therefore, the sealing ring can seal the gap between the housing 11 and the outer wall of the sound-emission nozzle 12 due to relative movement, avoiding a foreign object from entering the interior of the open earphone 100, ensuring the normal operation of the open earphone 100, and extending the service life of the open earphone 100.

In the open earphone of the embodiments, the sound-emission nozzle is movably connected to the housing, enabling telescopic movement of the sound-emission nozzle relative to the housing. When the open earphone is worn, the distance between the first sound-emission hole and the user’s ear canal opening may be adjustable. In this way, the open earphone can meet the needs for open wearing, and can also adjust the position of the sound-emission nozzle according to the ear sizes of different users when the users use the open earphone, so as to achieve the best wearing and listening effects. Through the design enabling the telescopic movement of the sound-emission nozzle relative to the housing, the open earphone can meet the needs of in-ear wearing, which can achieve better sound insulation effect.

In addition, in the open earphone of the embodiments, the first speaker is disposed in the sound-emission nozzle, and the second speaker is disposed in the housing. The first speaker and the second speaker are configured to be responsible for different frequency bands. For example, the first speaker is responsible for high-frequency, while the second speaker is responsible for medium-frequency and low-frequency. Due to shorter wavelength and higher directivity of high-frequency sound, the high-frequency sound is easy to concentrate and propagate at close range. The first speaker responsible for the high-frequency is disposed in the sound-emission nozzle and close to the first sound-emission hole, which can ensure better directionality and concentration of the high-frequency sound during propagation, reduce diffusion and attenuation of the high-frequency sound in a propagation path, thereby improving clarity and detail performance of the high-frequency sound. In contrast, low-frequency sound and medium-frequency sound have longer wavelengths and stronger diffusion, allowing them to propagate over a wider area. The second speaker responsible for the low-frequency and the medium-frequency is disposed in the housing, and an internal space of the housing may be utilized as a resonant cavity to enhance a resonance effect of the low-frequency sound and the medium-frequency sound, thereby improving the richness and the layering of the sound. Therefore, the setting of the open earphone can better utilize advantages of acoustic principles and structures, so as to improve sound quality performance of the open earphone.

The same or similar reference numbers in the accompanying drawings of the present disclosure correspond to the same or similar components. In the description of the present disclosure, if there are terms such as "up", "down", "left", "right" etc., the terms are based on the orientations or positional relationships shown in the accompanying drawings. The terms are only intended to facilitate the description of the embodiments of the present disclosure and simplify the description, but do not indicate or imply that the device or the element referred to have a specific orientation, be constructed and operated in a specific orientation. Therefore, the language used to describe positional relationships in the accompanying drawings is for illustrative purposes only and cannot be understood as limiting the present disclosure. For those of ordinary skill in the art, the specific meanings of the above terms can be understood according to specific situations.

The above embodiments are only the preferred embodiments of the present disclosure and are not intended to limit the present disclosure. Any modification, equivalent replacement, improvement, etc. made within the spirit and principle of the present disclosure should be included in the protection scope of the present disclosure.

1. An earphone, comprising:
a wearing part, configured to be disposed on an ear of a user;
a sound-production part, comprising a housing and a sound-emission nozzle, wherein the housing is connected to the wearing part, and the sound-emission nozzle defines a first sound-emission hole; and the sound-emission nozzle is telescopically movable relative to the housing, so that a distance between the first sound-emission hole and an ear canal opening of the user is adjustable when the earphone is worn by the user;
a first speaker, disposed in the sound-emission nozzle; and
a second speaker, disposed in the housing.

2. The earphone according to claim 1, wherein when the sound-emission nozzle is in a first position, the sound-emission nozzle is spaced apart from the ear canal opening.

3. The earphone according to claim 2, wherein the first sound-emission hole is defined on a front end of the sound-emission nozzle; and
when the sound-emission nozzle is in a second position, the front end of the sound-emission nozzle is configured to be inserted into the ear canal opening.

4. The earphone according to claim 3, wherein the sound-emission nozzle is able to telescopically move between the first position and the second position relative to the housing; and the earphone further comprises a circuit board disposed in the housing, the circuit board is configured to control the first speaker and the second speaker to operate simultaneously when the sound-emission nozzle is in the first position, and to control the first speaker to operate alone when the sound-emission nozzle is in the second position.

5. The earphone according to claim 4, wherein the earphone further comprises a detection assembly, the detection assembly is electrically connected to the circuit board, and the detection assembly is configured to detect position information of the sound-emission nozzle and send the position information to the circuit board; and
the circuit board is configured to control the first speaker and the second speaker to operate simultaneously when the circuit board receives the position information from the detection assembly indicating that the sound-emission nozzle is in the first position, and to control the first speaker to operate alone when the circuit board receives the position information from the detection assembly indicating that the sound-emission nozzle is in the second position.

6. The earphone according to claim 5, wherein the detection assembly comprises a detection member and a triggering member, the detection member is disposed in the housing and electrically connected to the circuit board, and the triggering member is disposed on the sound-emission nozzle.

7. The earphone according to claim 1, wherein the housing is disposed around the sound-emission nozzle, and a sound-emission channel is defined between the sound-emission nozzle and the housing; and a side wall of the sound-emission nozzle defines a sound-guiding hole, the housing defines a second sound-emission hole, and the sound-emission channel is in acoustic communication with the sound-guiding hole and the second sound-emission hole.

8. The earphone according to claim 7, wherein the sound-guiding hole is disposed closer to the second speaker than the first speaker.

9. The earphone according to claim 7, wherein an end of the housing away from the wearing part defines an installation port, the sound-emission nozzle is movably disposed in the installation port, and the sound-emission nozzle is able to telescopically move relative to the housing; and the earphone further comprises an elastic sealing member, and the elastic sealing member is disposed in the installation port and elastically abuts against an outer wall of the sound-emission nozzle.

10. The earphone according to claim 7, wherein the first speaker divides a space inside the sound-emission nozzle to form a first acoustic cavity that is disposed on a rear side of the first speaker, the second speaker divides a space inside the housing to form a second acoustic cavity that is disposed on a front side of the second speaker, the first acoustic cavity and the second acoustic cavity are in acoustic communication with each other and jointly form a coupling acoustic cavity, and the coupling acoustic cavity is in acoustic communication with the sound-guiding hole.

11. The earphone according to claim 1, wherein the earphone further comprises an adjustment mechanism, and the adjustment mechanism is configured to drive the sound-emission nozzle to telescopically move relative to the housing.

12. The earphone according to claim 11, wherein the adjustment mechanism comprises:
a piezoelectric vibrator; and
a friction member, disposed on an output terminal of the piezoelectric vibrator, wherein the friction member is in driving engagement with the sound-emission nozzle, so that the piezoelectric vibrator is able to drive the friction member to move, thereby driving the sound-emission nozzle to move along a telescopic direction;
wherein the first speaker defines a guiding hole, and a part of the friction member is configured to pass through the guiding hole.

13. The earphone according to claim 12, wherein the friction member is a carbon rod; and
a diameter of the guiding hole is greater than a cross-sectional diameter of the carbon rod by a value ranging from 0.5 mm to 1.5 mm.

14. The earphone according to claim 1, further comprising:
a noise-reduction microphone, disposed between the first speaker and the first sound-emission hole.

15. The earphone according to claim 1, further comprising:
an ear cap, disposed outside the sound-emission nozzle, wherein the ear cap defines a sound-production hole that is in acoustic communication with the first sound-emission hole and an external environment.

16. An earphone, comprising:
a sound-production part, comprising a housing and a sound-emission nozzle, wherein the sound-emission nozzle defines a first sound-emission hole; and the sound-emission nozzle is telescopically movable relative to the housing, so that a distance between the first sound-emission hole and an ear canal opening of a user is adjustable when the earphone is worn by the user;
a first speaker, disposed in the sound-emission nozzle; and
a second speaker, disposed in the housing.

17. The earphone according to claim 16, wherein when the sound-emission nozzle is in a first position, the sound-emission nozzle is spaced apart from the ear canal opening.

18. The earphone according to claim 17, wherein the first sound-emission hole is defined on a front end of the sound-emission nozzle; and
when the sound-emission nozzle is in a second position, the front end of the sound-emission nozzle is configured to be inserted into the ear canal opening.

19. The earphone according to claim 18, wherein the sound-emission nozzle is able to telescopically move between the first position and the second position relative to the housing; and the earphone further comprises a circuit board disposed in the housing, the circuit board is configured to control the first speaker and the second speaker to operate simultaneously when the sound-emission nozzle is in the first position, and to control the first speaker to operate alone when the sound-emission nozzle is in the second position.

20. The earphone according to claim 19, wherein the earphone further comprises a detection assembly, the detection assembly is electrically connected to the circuit board, and the detection assembly is configured to detect position information of the sound-emission nozzle and send the position information to the circuit board; and
the circuit board is configured to control the first speaker and the second speaker to operate simultaneously when the circuit board receives the position information from the detection assembly indicating that the sound-emission nozzle is in the first position, and to control the first speaker to operate alone when the circuit board receives the position information from the detection assembly indicating that the sound-emission nozzle is in the second position.
